(19) United States
(12) Patent Application Publication
(10) Pub. No.: US 2020/0240389 A1
(43) Pub. Date: Jul. 30, 2020

(54) Pump and drop electrical generation apparatus

(71) Applicant: Kenneth Miles Hanson, Oaksdale, WA (US)

(72) Inventor: Kenneth Miles Hanson, Oaksdale, WA (US)

(21) Appl. No.: 16/746,799

(22) Filed: Jan. 17, 2020

Related U.S. Application Data
(60) Provisional application No. 62/793,812, filed on Jan. 17, 2019.

(51) Int. Cl. F03B 15/02

(52) U.S. Cl. CPC F03B 15/02

(57) ABSTRACT

A pump storage hydroelectricity storage and generation system configured to burn un-scrubbed gas and generate electricity with minimal elevation differential between upper and lower fluid storage reservoirs.

### CROSS-REFERENCE TO RELATED APPLICATIONS

This application claims priority to provisional application 62/793,812 filed on Jan. 17, 2019.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable

### STATEMENT REGARDING PRIOR DISCLOSURES BY AN INVENTOR OR JOINT INVENTOR

Not Applicable

### BACKGROUND OF THE INVENTION

Pumped-storage hydroelectricity is a means of storing energy in the form of gravitational potential energy and then converting the gravitational potential energy into electrical energy through turbines when required. Pumped-storage accounts for approximately 95% of all active tracked storage around the world. Pumped storage allows energy to be consumed when it is least needed (and hence least expensive) to pump water to a higher elevation and convert that energy into gravitational potential energy. Electrical energy is most often used to pump the water though the source of that electrical energy depends on what is available and may include wind, solar, coal, or any other other electricity generation means. Once the system has gravitational potential energy, that gravitational potential energy may be converted into electricity by passing the water through turbines which are spun to create electricity. The type of turbine depends on the head, or pressure, and volume of the water.

Humphrey pumps, named for their inventor H A Humphrey, are internal-combustion fluidyne engines. They are characterized by having few, it any, moving parts apart from various valves, and exert combustion force directly on a mass of liquid rather than a mechanical piston. A Humphrey pump can operate in either a four-stroke or two-stroke cycle though the four-stroke is more common. In four-stroke operation, in the first outward stroke, the pressure on the water exerted by the force of the explosion and expansion of heated gasses sets the water column in motion with increasing velocity. The kinetic energy acquired by the rapidly moving column of water causes the water to flow outwards until a partial vacuum is formed at the combustion end of the playpipe. When the pressure falls to nearly that of the atmosphere the exhaust valves open inwardly with the assistance of springs. The lightly spring-loaded water inlet valves open inwards admitting a large quantity of new water into the playpipe, partly to follow the column of outgoing moving water and partly to fill the pipe to the same level as the water in the suction sump. With a further fall in pressure, the scavenge air valves, also lightly spring loaded, open, allowing atmospheric air to be admitted to occupy the space above the exhaust valve level, a retentive valve in the exhaust valve casing preventing the return of burnt gases from the exhaust pipe. By means of an interlocking apparatus operated by pressures within the combustion head, the exhaust and scavenge air valves were released when the explosion occurred and the gas mixture valves were locked in the closed position. A portion of the outgoing water column spills out into the receiving basin, starting a siphoning action in the outlet discharge pipe.

In the first return stroke, the momentum of the water column expends itself at the end of the first outward stroke, allowing the water column to flow back by gravitational force towards the combustion head. This in turn drives the burnt products of combustion through the open exhaust valves, ultimately closing them by impact of the water. The spring loaded water inlet and scavenge air valves were closed when the pressure again rose to approximately that of the atmosphere. The returning water column, having gained considerable velocity, now compresses the scavenge air (mixed with a percentage of spent gasses) in the top of the combustion chamber, forming a compressed elastic cushion. The energy thus stored in this cushion is then equal to the energy given out by the rapidly moving water column, urged on by the static head behind it, so that the cushion pressure is considerably in excess of that due to the static head. The interlocking mechanism, now operated by the cushion pressure, automatically releases the catch from the mixture valves and locks the exhaust and scavenge air valves.

In the second outward stroke, the expansion of the compressed air cushion now drives the water column outward again, the pressure becoming atmospheric as the surface reaches the exhaust valve level, and if it were not for the friction losses in the playpipe, it would ultimately be driven out to the same position that it occupied prior to the commencement of the first return stroke. The outward movement of the water column continues until a partial vacuum is again formed and the water inlet valves open, admitting a large quantity of water into the playpipe. A portion of the water column at the outward end again overflows into the receiving basin. The gas mixture valves alone being free to operate, a new charge of gas and a small amount of air is admitted into the combustion chamber, which mingling with the scavenge air taken in on the previous stroke, forms a fresh combustion mix.

In the second return stroke, the second outgoing impetus given to the water column having expended itself, a return flow again takes place, and, all valves being closed, the new charge is compressed and fired automatically at the moment of maximum compression. The electric current to coils is switched on by a plunger-operated ignition mechanism. Thus another cycle commences, and providing that the correct mixture of air and gas is admitted by the proper functioning of valves and the correct timing of ignition gear, the four cycles continue with a regular pendulum action of the water column, although the length of the strokes are unequal. A portion of the water column is discharged into the receiving basin on each outward stroke.

The Humphrey pump has a maximum lift of approximately 10 meters. It also requires a gas energy source though a wide variety of gases are suitable. Humphrey pumps are well suited to operate on fuels which may be contain too many impurities for other internal combustion processes. Since the piston is the fluid being pumped, residues and other impurities accumulate in the chamber to a much lesser degree than they accumulate in conventional internal combustion engines. Humphrey pumps have been limited in where they can be installed due to the high level of carbon monoxide released by burning producer gas (commonly used to fuel Humphrey pumps). Humphrey pumps have also been limited in where they are installed because Humphrey pumps are optimized for moving large volumes of fluid relatively low elevations (contrasted with other pumps which are capable of lifting fluids to much greater heights).

Unprocessed natural gas is commonly known as sour gas or flare gas. It generally contains more than 5.7 milligrams of hydrogen sulfide per cubic meter. Wellhead gas is generally cleaned through a three-step process. First, the gas is scrubbed. In the scrubbing process, water and oil condensates are removed from the gas. Second, the gas is dehydrated. Gas is dehydrated either by using a dehydrating agent (liquid such as diethylene glycol, or solid such as silica gel or activated alumina) or by condensing and collecting the water vapor. Third, the gas is filtered. Filtration generally involves passing the gas through a tower containing an amine solution with an affinity for sulfur (for sulfur reduction) or other material for removing other impurities from the gas.

Low-head hydropower is the generation of electrical energy from gravitational potential energy where the water having the gravitational potential energy has a head of 20 meters or less. A variety of turbines are adapted to specific low head applications including: axial flow rotor turbines, open center fan turbines, helical turbines, cycloidic turbines, hydroplane blades, an FFP turbine generator, a gravitation water vortex power plant, and an Archimedean screw.

### DESCRIPTION OF RELATED ART INCLUDING INFORMATION DISCLOSED UNDER 37 CFR 1.97 AND 37 CFR 1.98

Not Applicable

### BRIEF SUMMARY OF THE INVENTION

A pumped-storage hydroelectricity system using a Humphrey pump to move fluid to an elevated position to be converted into electricity.

### BRIEF DESCRIPTION OF THE SEVERAL VIEWS OF THE DRAWING

FIG. 1 shows a preferred process of the applicant's invention.

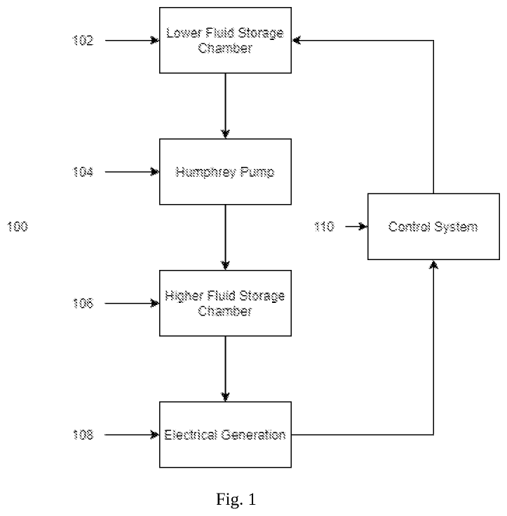

### DETAILED DESCRIPTION OF THE INVENTION

The applicant's invention is a pumped-storage hydroelectricity generation system. The applicant's invention is preferably a closed system wherein fluid begins in a first lower fluid storage reservoir 102. The fluid is then raised from the lower fluid storage reservoir 102 to a second higher fluid storage reservoir 106 using a pump 104 of some type. In a preferred embodiment, the applicant's invention uses a Humphrey pump to move fluid from the first lower fluid storage reservoir 102 to the second higher fluid storage reservoir 106 in a generally closed loop.

The applicant's system is further operable to generate electricity from flammable gasses which are not suitable for other purposes due to location, gas contaminents/composition. In each of years 2011-2017, between 200,000 and 300,000 million cubic feet of natural gas were vented and flared in the United States according to data provided by the US Energy Information Administration.

In a preferred embodiment, the fluid is water due to its low reactivity and low toxicity. In this embodiment, water is used as a starting fluid. Exhaust gases, particulate, and other exhaust materials are added inherently by the water's operation as a piston in a Humphrey pump. In a variation of this embodiment, exhaust materials from the pump operation are intentionally injected into the operating fluid. When, due to the addition of exhaust materials, the fluid becomes a solution of a particular concentration, the fluid may be cleaned or put to a beneficial use and the fluid in the system replaced. In alternative embodiments, a fluid other than water is used.

The fluid is selectively allowed to flow from the second higher fluid storage reservoir 106 to the first lower fluid storage reservoir 102 through an electrical generation apparatus 108.

The applicant's process 100 preferably uses an Archimedes screw turbine to convert gravitational potential energy in fluid contained in the second higher fluid storage reservoir 106 into electrical energy 108 as the fluid flows into the first lower fluid storage reservoir 102. This electricity may be generated at the same time as fluid is being moved from the first lower fluid storage reservoir 102 to the second higher fluid storage reservoir 106 or at a later time. The Archimedes screw turbine is well adapted to fluids which contain significant impurities, including sediment and has a long service life (often about 30 years) with minimal maintenance. In an alternative embodiment, a Kaplan turbine is used instead of an Archimedes screw. A variety of other electrical generation mechanisms and techniques are well known in the art and are within the scope of the applicant's invention. The specific mechanism for converting gravitational potential energy to electricity is preferably selected to balance high efficiency with low maintenance based on the pressure and volume of fluid.

In a preferred embodiment, a control system 110 controls fuel provided to the pump 104 and a valve between the higher fluid storage chamber 106 and the lower fluid storage chamber 102. Fuel is provided to the pump 104 when it is advantageous to add gravitational potential energy to the system. The valve between the higher fluid storage chamber 106 and the lower fluid storage chamber 102 is opened when it is advantageous to generate electrical energy. It may, but need not, be advantageous to simultaneously add energy to the system and generate electrical energy.

The applicant's process reduces the cost of converting chemical energy into electrical energy by reducing the cost of purifying (or scrubbing) the fuel gas prior to use. The process further is readily adaptable to operate on a variety of flammable gasses. In a preferred embodiment, the pump may use a variety of fuel injection schemes, including, but not limited to, multi port injection and ignition. Conventional internal combustion engines require relatively clean fuel since the tolerances are fairly tight to allow a seal between the piston and the cylinder. Deposits on the cylinder walls from impure fuels wear the seals. In contrast, the only moving parts to a Humphrey pump are valves. There are no fixed pistons since the fluid being pumped is the piston. Therefore, Humphrey pumps are able to operate on fuel containing contains impurities which would not be suitable for conventional internal combustion engines. Further, because the operating fluid is preferably used in a closed loop, and particularly if exhaust is injected into the operating fluid, the fluid may be used to capture exhaust materials which would otherwise undesirably be vented. Additionally, because the fluid is used as a closed loop, the system may become more efficient. Heat from the fluid being used as the piston in a Humphrey pump will, at least in part, be transferred into the fluid. Because the viscosity of water, and may fluids, decreases as the temperature of the fluid increases, the operating fluid will induce less friction as it is moved through pipes as it is lifted by the pump.

In an alternative embodiment, steam energy is used in place of, or in addition to, the Humphrey pump, when steam energy is available, such as when direct sunlight is available.

The applicant's process, by virtue of the Humphrey pump and Archimedes screw turbine, is adapted to operate on fluids which contains significant impurities. The applicant's process requires fewer screens and other mechanisms to filter debris from the fluid which would jam the pump than other pumping mechanisms. Conventional turbines, particularly those adapted to high pressure, also require screens and other mechanisms to filter out debris which would significantly wear the turbine blades. In the applicant's process, debris which would prevent a valve from closing is a concern, but debris which would interfere with a pump diaphragm or impeller need not be remediated.

The applicant's invention further reduces energy transportation costs. The applicant's process is uniquely adapted to remote and small-scale power generation. Electrical transmission lines are substantially less expensive ( 1/30th to ¼th the cost) than pipelines for transporting either gases or liquids. Transmitting electrical energy is also better suited for intermittent demand-based use because pipelines are subject to freezing and may require constant pressurization to avoid contamination. Further, electrical transmission lines are more geographically dispersed than gas or fluid pipelines and already available at many wells which produce gases which are suitable for use as fuel for the applicant's process.

The applicant's invention preferably uses existing gas producing infrastructure. In a preferred embodiment, gas which would otherwise be burned by flaring is used to fuel the Humphrey pump. In a first alternative embodiment, syngas is used to fuel the Humphrey pump. In a second alternative embodiment, hydrogen generated directly or indirectly by solar energy, electricity, or electrolysis is used to fuel the Humphrey pump. In a third alternative embodiment, a steam engine is used to lift the fluid instead of a Humphrey pump. In a fourth alternative embodiment, another conventional pumping mechanism is used.

In a preferred embodiment, the exhaust gas from the Humphrey pump is collected and stored for a beneficial use. In a preferred embodiment, the gas is collected in a silo adapted for gas storage. The silo preferably has a gas and liquid impermeable bladder in the bottom of the silo. There is preferably disposed above the bladder a pressure applying means configured to apply pressure on the bladder. In a preferred embodiment, the pressure applying means is a column of water. In a further preferred embodiment a relatively rigid member is disposed between the column of water and the bladder to prevent portions of the bladder from extending above the pressure applying means (similar to a hernia) thereby stressing the bladder and impeding the pressure applying means from applying constant pressure on the bladder. In an alternative embodiment, the gas collection system is used to store gas to be burned in the Humphrey pump.

In a preferred embodiment, the collected exhaust gas is used to produce ethanol through a biological process. Certain bacteria are able to feed on gasses, particularly hydrogen, carbon monoxide, carbon dioxide, and methane. Processes, such as those popularized by LanzaTech are well known in the art. Clostridium autoethanogenum is one such anaerobic bacterium which produces ethanol from carbon dioxide. In a conventional process, a carbon gas stream from an industrial source (such as steel manufacturing), biogas (such as from agricultural animal facilities), gassification from a solid waste stream, biomass (such as accumulated agriculture materials like straw) is accumulated, compressed, and directed into a fermentation chamber. In the fermentation chamber, bacteria feed on the carbon-rich gas and excrete ethanol as waste. The waste is fed into a recovery vessel where the desired product, such as ethanol, is concentrated. The concentrated output is then fed into, and stored in, a product tank.

### SEQUENCE LISTING

Not Applicable

1. An apparatus for generating electrical energy from chemical energy comprising:
A) a first liquid storage container,
B) a second liquid storage container at a higher elevation than said first liquid storage container in fluid communication with said first liquid storage container,
C) a Humphrey pump configured to move liquid from said first liquid storage container to said second liquid storage container,
D) a fluid communication means for liquid to pass from said second liquid storage container to said first liquid storage container, and
E) an electrical generation means disposed in said fluid communication means configured to generate electricity from liquid passing from said second liquid storage container to said first liquid storage container.

2. The apparatus of claim 1 further comprising:
A) means for selectively substantially closing said fluid communication means for liquid to pass from said second liquid storage container to said first liquid storage container thereby preventing the passage of liquid from said second liquid storage container to said first liquid storage container.

3. The apparatus of claim 2 further comprising:
A) a control system configured to:
I) selectively activate and deactivate said Humphrey pump and
II) selectively activate and deactivate said electrical generation means.

4. The apparatus of claim 3 wherein said electrical generation means comprise an Archimedes screw turbine.

5. The apparatus of claim 3 wherein said electrical generation means comprise a Kaplan turbine.

6. The apparatus of claim 3 further comprising:
A) means for capturing exhaust of said Humphrey pump.

7. The apparatus of claim 6 further comprising:
A) means for diffusing exhaust captured from said Humphrey pump into a liquid.

8. The apparatus of claim 7 wherein:
A) means for diffusing exhaust captured from said Humphrey pump into the liquid being pumped by said Humphrey pump.

9. The apparatus of claim 8 further comprising:
A) a fermentation chamber containing an environment favorable to anaerobic bacterium.

10. The apparatus of claim 9 wherein:
A) means for circulating said fluid being pumped by said Humphrey pump, with diffused exhaust gas, through said fermentation chamber.

11. The apparatus of claim 3 wherein:
A) said control system selectively activates and deactivates said Humphrey pump and electrical generation means in response to inputs comprising one or more of:
I) current market price of electricity,
II) current price of fuel for said Humphrey pump,
III) permit requirements concerning permissible amounts of gas which may be vented, flared, or otherwise be released.
